(19) United States
(12) Patent Application Publication
(10) Pub. No.: US 2012/0256958 A1
(43) Pub. Date: Oct. 11, 2012

(54) PORTABLE TERMINAL DEVICE, DISPLAYING SYSTEM, AND METHOD OF CONTROLLING DISPLAY ON PORTABLE TERMINAL DEVICE

(75) Inventor: Kazunori Hirabayashi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/438,092

(22) Filed: Apr. 3, 2012

Related U.S. Application Data
(60) Provisional application No. 61/472,666, filed on Apr. 7, 2011.

(51) Int. Cl. G09G 5/00

(52) U.S. Cl. 345/635

(57) ABSTRACT

According to the embodiment, a portable terminal device generally includes a terminal display screen, an accepting section, and a display controller. The terminal display screen has an aspect ratio determined between a length and a width different from each other. The accepting section accepts instructions of change to change the display condition of the terminal display screen. The display controller changes the display condition of the terminal display screen from a first display condition of displaying a first image to a second display condition in response to acceptance of the instructions of change by the accepting section. The second display condition is such that the first image displayed in the second display condition is reduced in size when compared with that of the first display condition, and that a second image not displayed in the first display condition is displayed in an empty region formed by reducing the size of the first image.

### CROSS-REFERENCE TO RELATED APPLICATION

This application is based upon and claims the benefit of priority from U.S. provisional application 61/472,666, filed on Apr. 7, 2011; the entire contents of which are incorporated herein by reference.

### FIELD

Embodiments described herein relate generally to a technique of controlling display on a portable terminal device.

### BACKGROUND

According to a recently devised displaying system used in a situation such as a meeting in which a presentation is given, an image displayed on a portable terminal device of each participant in a meeting is synchronized with an image displayed on a portable terminal device of a presenter who gives a presentation. In this displaying system, a page image currently displayed on the portable terminal of the presenter appears on the portable terminal device of each participant. If a page image of a next page is displayed on the portable terminal device of the presenter, the page image of the next page is also displayed on the portable terminal device of each participant.

However, the conventional displaying system allows a page image of only one page displayed on the portable terminal device of the presenter to appear on a display screen of a portable terminal of a participant. This means that the conventional displaying system leaves room for more effective use of a display screen of a portable terminal device of a participant.

### DESCRIPTION OF THE DRAWINGS

FIG. 1 is a diagram showing a displaying system.

FIG. 2 is a block diagram showing the hardware configuration of a portable terminal device.

FIG. 3 is a functional block diagram of the portable terminal device.

FIG. 4 is a flowchart explaining respective processes performed by the displaying system.

FIG. 5 shows a page image in a document file placed in a landscape position.

FIG. 6 shows a page image in a document file placed in a portrait position.

FIG. 7 is a diagram for explaining displaying process on a portable terminal device of a participant.

FIG. 8 is a diagram showing a display style on a portable terminal device in a first display condition.

FIG. 9 is a diagram showing an example of a display style on a portable terminal device in a second display condition.

FIG. 10 is a diagram showing a different example of use of a second divided region.

FIG. 11 is a diagram showing a different, example of use of the second divided region.

FIG. 12 is a diagram showing a different example of use of the second divided region.

FIG. 13 is a diagram showing the operation of a portable terminal device.

FIG. 14 is a diagram showing how a selected page image is displayed in an enlarged style in the second divided region.

### DETAILED DESCRIPTION

According to an embodiment, a portable terminal device generally includes a terminal display screen, an accepting section, and a display controller. The terminal display screen has an aspect ratio determined between a length and a width different from each other. The accepting section accepts instructions of change to change the display condition of the terminal display screen. The display controller changes the display condition of the terminal display screen from a first display condition of displaying a first image to a second display condition in response to acceptance of the instructions of change by the accepting section. The second display condition is such that the first image displayed in the second display condition is reduced in size when compared with that of the first display condition, and that a second image not displayed in the first display condition is displayed in an empty region formed by reducing the size of the first image.

The embodiment is described below with reference to the drawings.

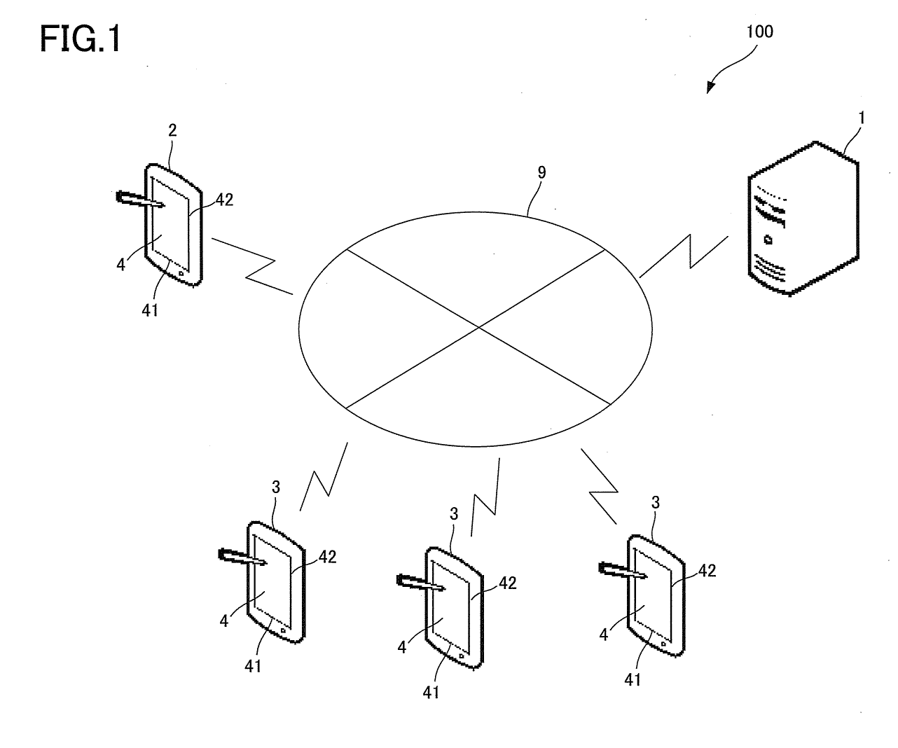

FIG. 1 is a diagram showing a displaying system 100.

The description of the embodiment is based on the assumption that the displaying system 100 is used in a presentation given during a meeting. The displaying system 100 is usable in various situations and for various purposes as well as in a presentation during a meeting.

The displaying system 100 includes a server 1, a portable terminal device 2 (display device) used by a presenter for a presentation, and portable terminal devices 3 used by participants in a meeting.

The server 1 is connected through a network 9 to the portable terminal devices 2 and 3.

The portable terminal devices 2 and 3 each have a rectangular display screen 4 (terminal display screen) with screen's short sides 41, and screen's long sides 52 meeting the screen's short sides 41 at right angles and longer than the screen's short sides 41. To be specific, the portable terminal devices 2 and 3 each have an aspect ratio determined between a length and a width different from each other. The aspect ratio is 16:9. The aspect ratio may be a different ratio such as 4:3.

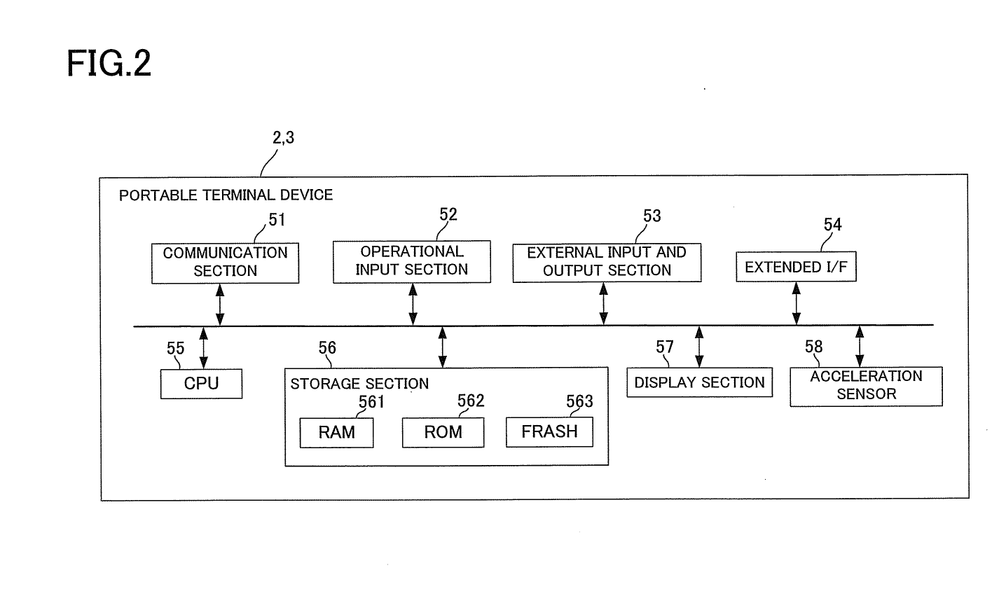

FIG. 2 is a block diagram showing the hardware configuration of each of the portable terminal devices 2 and 3.

The portable terminal devices 2 and 3 each include a communication section 51, an operational input section 52, an external input and output section 53, an extended I/F (interface) 54, a CPU (central processing unit) 55, a storage section 56, a display section 57, and an acceleration sensor 58.

The communication section 51 makes wireless communications with an external unit, and forms the network 9 such as a LAN (local area network) together with the external unit.

The operational input section 52 accepts operational input. The operational input section 52 is a touch panel, and is integral with the display section 57. The operational input section 52 and the display section 57 may be separated parts.

The external input and output section 53 processes input and output of a signal from and to an external unit such as a USB (universal serial bus) connected to each of the portable terminal devices 2 and 3.

The extended I/F 54 is connected to a memory card and the like, and extends the function of each of the portable terminal devices 2 and 3.

The CPU 55 is a controller. The CPU 55 controls each of the portable terminal devices 2 and 3 entirely by processing a program read from the storage section 56, thereby realizing various functions.

The storage section 56 includes a RAM (random-access memory) 561, a ROM (read- only memory) 562, and a flash memory 563.

The display section 57 is a touch panel. The display screen 4 of the display section 57 is rectangular.

The acceleration sensor 58 measures the acceleration of gravity acting, for example, in the triaxial direction (in other words, detects the position of the display screen 4).

Like the portable terminal devices 2 and 3, the server 1 includes a communication section, an operational input section, an external input and output section, an extended I/F, a CPU, and a storage section.

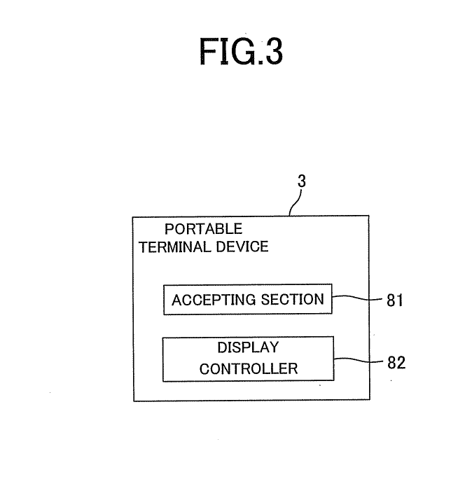

FIG. 3 is a functional block diagram of the portable terminal device 3.

The portable terminal device 3 includes an accepting section 81 and a display controller 82 serving as functional parts of the portable terminal device 3. The accepting section 81 includes the CPU 55 and the acceleration sensor 58 as the hardware of the accepting section 81. The display controller 82 includes the CPU 55 as the hardware of the display controller 82. The functions of the accepting section 81 and the display controller 82 are described later.

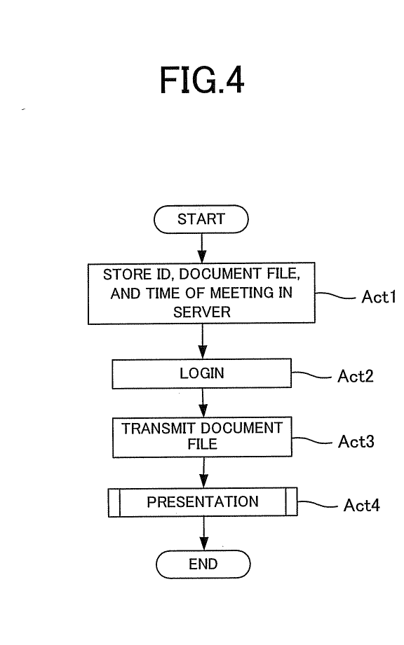

Respective processes performed in the displaying system 100 when the displaying system 100 is used in a presentation given during a meeting are explained with reference to the flow chart of FIG. 4.

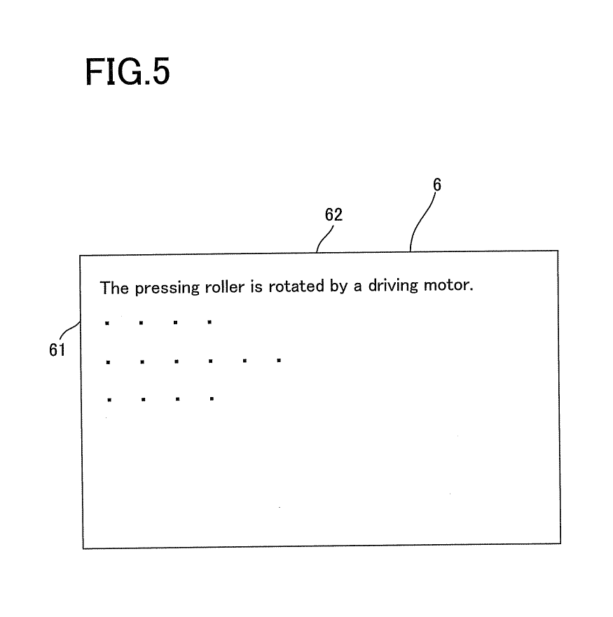

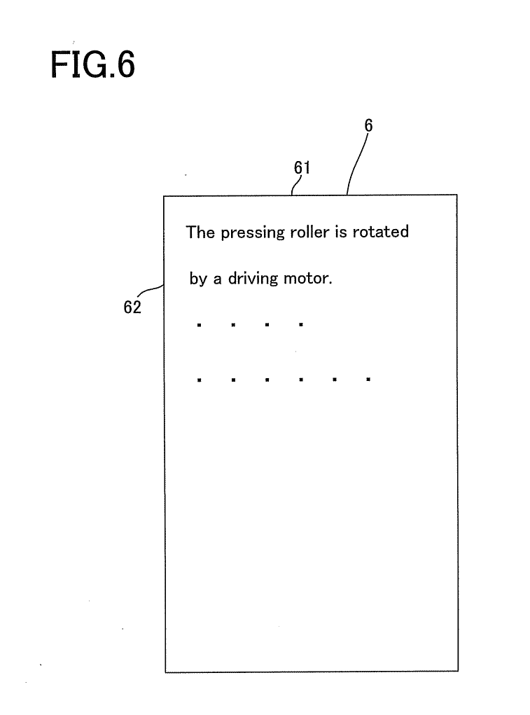

The server 1 stores the ID (identification) of a person to attend a meeting, a document file used in the meeting, time of the meeting , and others (Act 1). The ID, the document file, and the time of the meeting are entered into the server 1 by a presenter, for example, by using an external unit before the meeting is started. The document file includes a plurality of pages. As shown in FIG. 5, a page image 6 of each page is in the form of a rectangle with page's short sides 61, and page's long sides 62 meeting the page's short sides 61 at right angles and longer than the page's short sides 61. If the position of a page image 6 makes the page image 6 horizontally long as viewed from a person, this position of the page image 6 is called a landscape position. As shown in FIG. 6, if the position of a page image 6 makes the page image 6 vertically long as viewed from a person, this position of the page image 6 is called a portrait position. An aspect ratio corresponding to a ratio between the page's long sides 62 and the page's short sides 61 is 16:9. The aspect ratio of a page image 6 may be a different ratio such as 4:3.

The portable terminal devices 2 and 3 each accept an ID, and log into the server 1 (Act 2).

The server 1 allows login if the ID received from each of the portable terminal devices 2 and 3 is an ID registered in advance, and if the ID is accepted within the set time of a meeting. The server 1 transmits a document file to the portable terminal devices 2 and 3 having logged into the server 1 (Act 3).

The portable terminal device 2 of a presenter switches a page image 6 by turning page images 6 in a document file sequentially, for example, in response to operation by a presenter, and transmits display page information indicating a page image 6 to be displayed to the portable terminal device 3 through the server 1. The portable terminal device 3 of a participant receives the display page information. To be specific, the portable terminal device 3 of the participant is synchronized with the portable terminal device 2 of the presenter, and then displays a page image 6 appearing on the portable terminal device 2 of the presenter (Act 4). This allows the presenter to give a presentation while operating the portable terminal device 2 of the presenter himself or herself to present a desired page image 6 in the document file to the participant.

In response to instructions to finish the meeting given from one of the portable terminal devices 2 and 3 of the presenter and the participant, or in response to arrival of set termination time of the meeting, the server 1 instructs the portable terminal devices 2 and 3 to prohibit display of the document file. This makes it impossible for the presenter and the participant to see the document file after the meeting is finished.

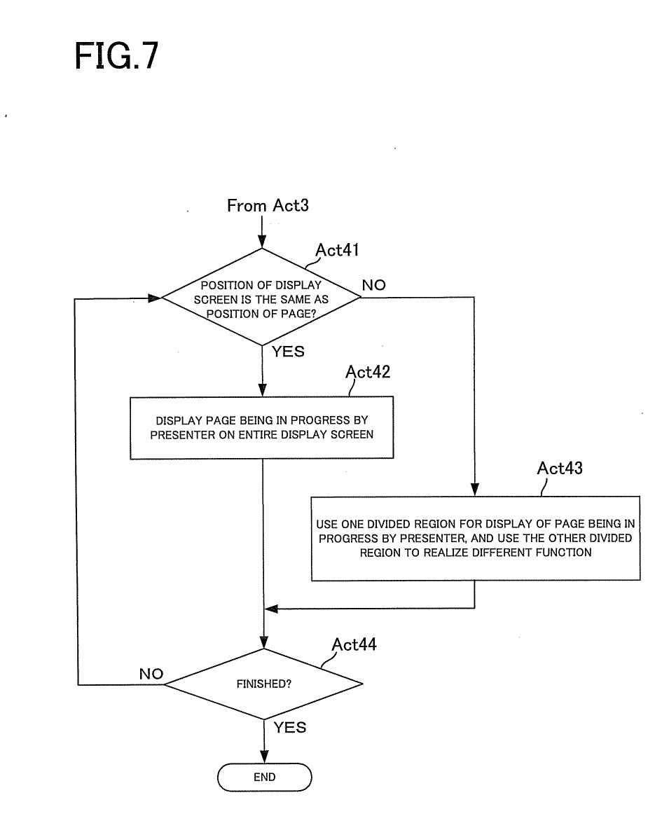

Displaying process on the portable terminal device 3 of the participant performed in Act 4 is explained with reference to the flow chart of FIG. 7.

The accepting section 81 of the portable terminal device 3 determines if the display screen 4 is in the landscape or portrait position on the basis of an output signal from the acceleration sensor 58. The position of the display screen 4 making the display screen 4 horizontally long as viewed from a person is called a landscape position, and the position of the display screen 4 making the display screen 4 vertically long as viewed from a person is called a portrait position. The accepting section 81 determines if the position of the display screen 4 agrees with the position of a page image 6 in the document file (Act 41).

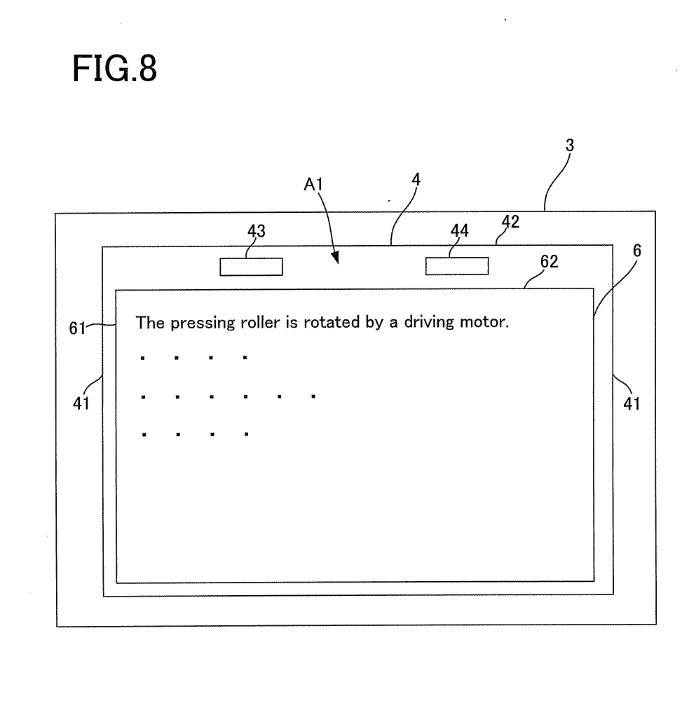

FIG. 8 is a diagram showing a display style on the portable terminal device 3 in a first display condition.

If the accepting section 81 determines that the position of the display screen 4 agrees with the position of a page image 6 in the document file (Act 41, YES), the display controller 82 displays the page image 6 in the document file in a region A1 extending between one and the other of the screen's short sides 41 of the display screen 4, namely in the substantially entire region of the display screen 4 (Act 42).

At this time, the portable terminal device 3 is in synchronization with the portable terminal device 2 of the presenter. The display controller 82 displays a page image 6 on the display screen 4 that is appearing on the portable terminal device 2 of the presenter. Accordingly, if the portable terminal device 2 switches a page image 6 in response to the presenter's operation, the display controller 82 complies with the switching of the page image 6 on the portable terminal device 2 to switch a page image 6 displayed on the display screen 4. A page image 6 (first image) displayed on the display screen 4 by the display controller 82 has the same aspect ratio as that of a page image 6 displayed on the portable terminal device 2.

The first display condition is a condition of the display screen 4 where a page image 6 is displayed in the region A1 extending through the display screen 4. In FIG. 8, elements identified by reference numbers 43 and 44 are display buttons with which the portable terminal device 3 is operated.

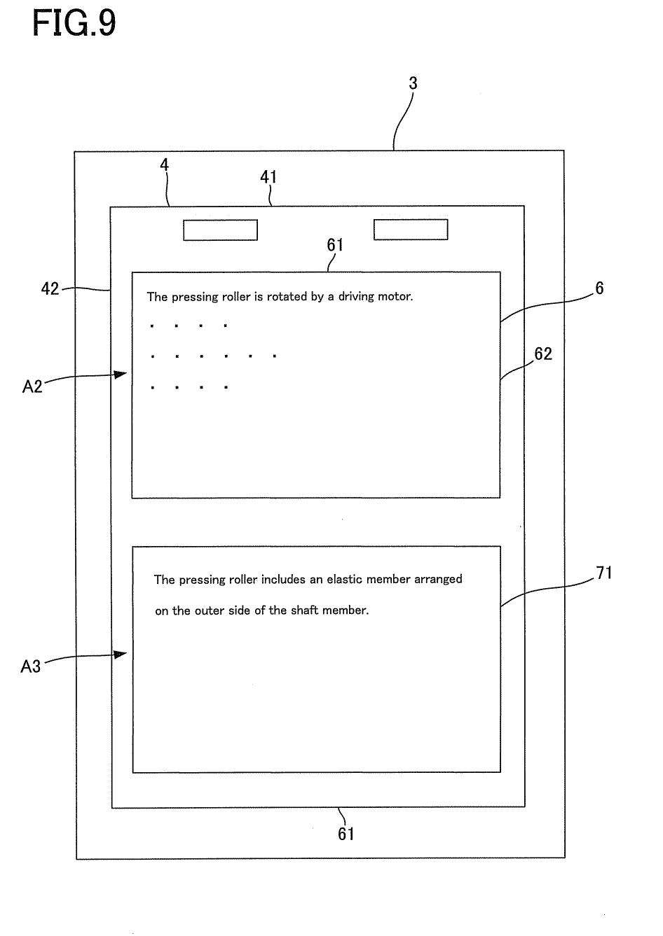

FIG. 9 is a diagram showing an example of a display style on the portable terminal device 3 in a second display condition.

If the accepting section 81 determines that the position of the display screen 4 is different from the position of a page image 6 in the document file (Act 41, NO), the display controller 82 changes the display condition of the display screen 4 from the first display condition to the second display condition.

More specifically, in the second display condition, the display controller 82 displays a page image 6 appearing on the portable terminal device 2 of the presenter in a first divided region A2 of the display screen 4 closer to one of the screen's short sides 41. At this time, the display controller 82 displays the page image 6 with a reduced size in the first divided region A2 while maintaining the aspect ratio of the page image 6 at a set value. At the same time, the display controller 82 displays an image (second image) in a second divided region A3 that is not shown in the first divided region A2 (Act 43). The second divided region A3 is an empty region formed by displaying the page image 6 with a reduced size, namely, a region closer to the other of the screen's short sides 41.

In the second display condition, the display controller 82 divides the display screen 4 to be used. Further, the display controller 82 makes the first divided region A2 function only as a region where a page image is displayed with a reduced size in synchronization with a page image 6 on the portable terminal device 2 of the presenter. Meanwhile, the display controller 82 is capable of realizing various functions by using the second divided region A3. The embodiment realizes a plurality of functions by using the second divided region A3, and these functions can be changed from one to another.

For example, the display controller 82 uses the second divided region A3 as a region where a text input screen 71 is shown as a notepad. Text entered through the text input screen 71 can be saved.

If the portable terminal device 3 in the condition of FIG. 8 is rotated in a plane including the display screen 4, the accepting section 81 accepts instructions of change to change the condition of the display screen 4 (Act 44, NO and Act 41, NO) . Acceptance of the instructions of change by the accepting section 81 means that the accepting section 81 determines on the basis of an output signal from the acceleration sensor 58 that the position of the display screen 4 has been changed between the landscape position and the portrait position.

After acceptance of the instructions of change (Act 41, NO), the display controller 82 changes the display condition of the display screen 4 from the first display condition of FIG. 8 where only a page image 6 (first image) appearing on the portable terminal device 2 of the presenter is displayed to the second display condition of FIG. 9 where the page image 6 of a size reduced when compared with that of the first display condition is displayed (Act 43). In the second display condition, the display controller 82 displays the text input screen 71 (second image) in the empty region A3 formed by reducing the size of the page image 6 and not shown in the first display condition.

As described above, in the embodiment, the display screen 4 is generally placed in the landscape position if the position of a page image 6 in a document file is in the landscape position, allowing the participant to see a page image 6 on the entire display screen 4 in synchronization with the progress of the page image 6 of the presenter. If the participant wants to take a note, the participant may place the display screen 4 in the portrait position by rotating the display screen 4. As a result, the participant is allowed to take a note on the text input screen 71 displayed in the second divided region A3 and save the note while seeing a page image 6 in synchronization with page progress by the presenter and displayed with a reduced size in the first divided region A2. The participant is also allowed to see a page image 6 on the entire display screen 4 that is in synchronization with the progress of the page image 6 by the presenter by changing the position of the display screen 4 again from the portrait position to the landscape position.

In response to instructions to finish the meeting given from the presenter or the participant to the server 1 through the portable terminal device 2 or 3, or in response to arrival of set termination time of the meeting, the portable terminal devices 2 and 3 receive instructions from the server 1 to prohibit display of the document file (Act 44, YES). As a result, the portable terminal devices 2 and 3 finish display of a page image 6 in the document file.

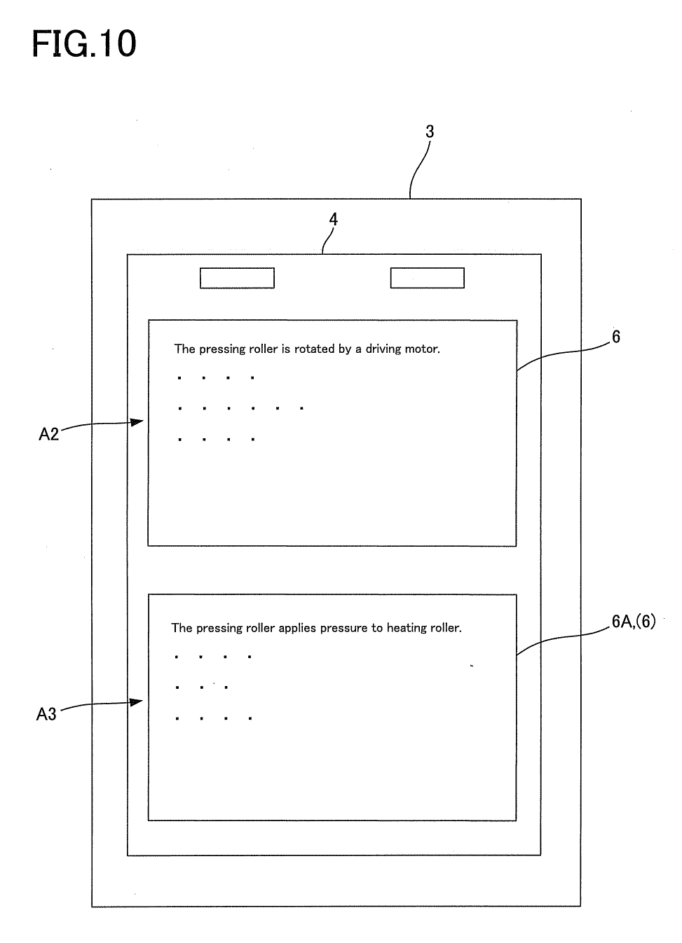

FIG. 10 is a diagram showing a different example of use of the second divided region A3.

The display controller 82 uses the second divided region A3 as a region where one appropriate page image 6A (6) in a document file is displayed. The display controller 82 displays, in the second divided region A3, the page image 6A of a preceding page immediately previous to the page of a page image 6 displayed in the first divided region A2 (or previous to the page of the page image 6 with pages of a set number existing between the page of the page image 6A and the that of the page image 6). In response to flick to the right of FIG. 10 in the second divided region A3, the display controller 82 displays, in the second divided region A3 , a page image 6A that is a page image of a preceding page immediately previous to the page of a page image 6A currently displayed in the second divided region A3. Further, in response to flick to the left of FIG. 10 in the second divided region A3, the display controller 82 displays, in the second divided region A3, a page image 6A that is a page image of a subsequent page immediately next to the page of a page image 6A currently displayed in the second divided region A3. The display controller 82 makes the size of a page image 6A be reduced when compared with that of the first display condition while maintaining the aspect ratio thereof, and displays the page image 6A in the second divided region A3.

The display controller 82 gives a colored frame and the like to a page image 6 in synchronization with page progress by a presenter shown in the first divided region A2, thereby displaying the page image 6 in the first divided region A2 more pronouncedly than a page image 6A displayed in the second divided region A3.

In this example, if a page image 6 in a document file is in the landscape position, a participant may change the position of the portable terminal device 3 to the portrait position by rotating the portable terminal device 3. Thus, the participant is allowed to see a desired page image 6A in the document file in the second divided region A3 while looking at the page image 6 in the first divided region A2 that is being in progress by a presenter.

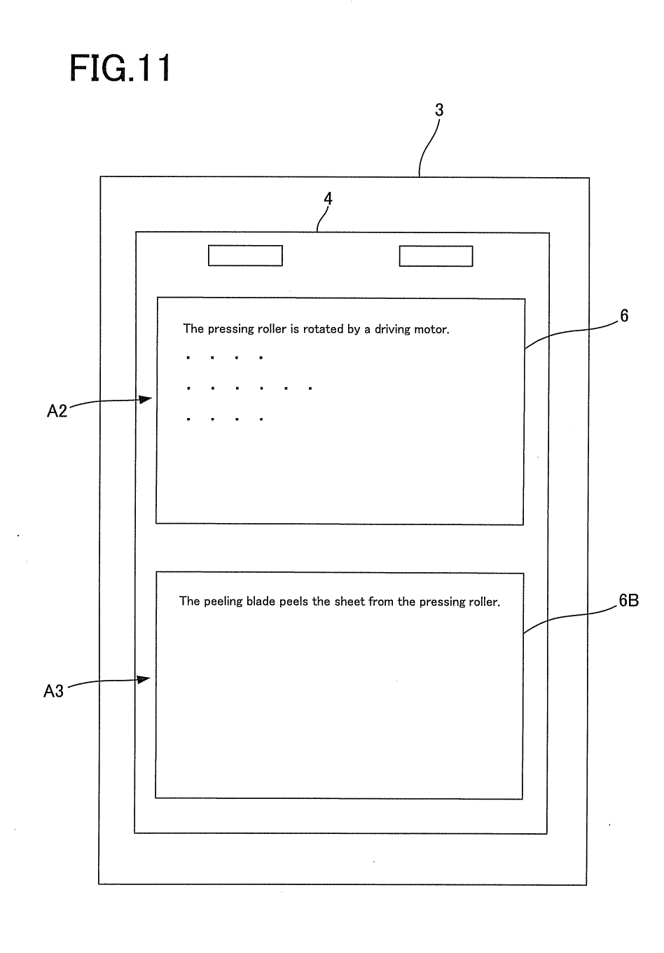

FIG. 11 is also a diagram showing a different example of use of the second divided region A3.

The display controller 82 uses the second divided region A3 as a region where a document file stored in the portable terminal device 3 is opened, for example. The document file stored in the portable terminal device 3 is different from a document file transmitted from the server 1. In this example, a participant can open a desired document file in the second divided region A3 being a different material stored in the portable terminal device 3 by operating the portable terminal device 3. Thus, the participant is allowed to see a page image 6B in the desired document file opened in the second divided region A3 while looking at a page image 6 in the first, divided region A2 that is being in progress by a presenter.

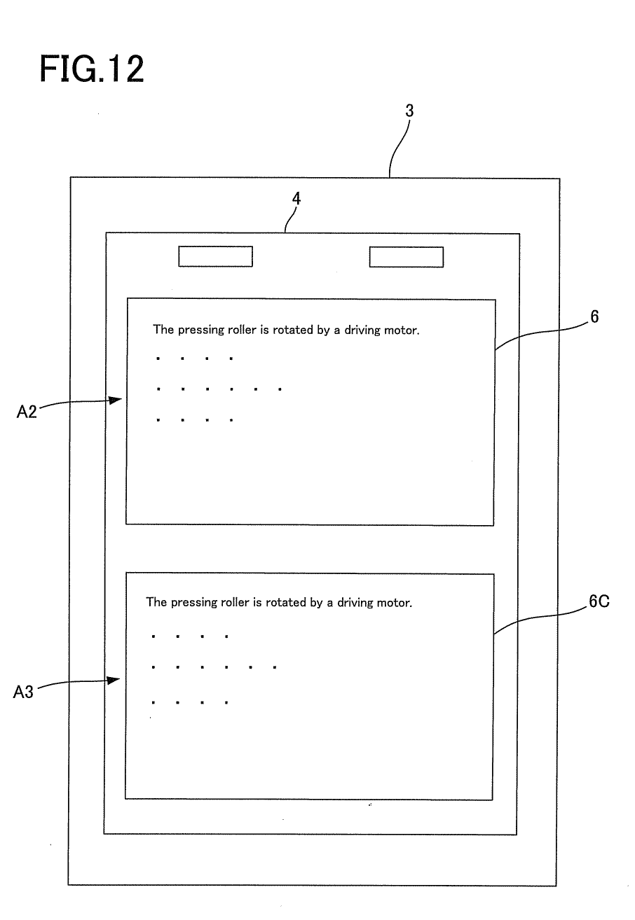

FIG. 12 is also a diagram showing a different example of use of the second divided region A3.

The display controller 82 uses the second divided region A3 as a region where a material supplementary to a page image 6 being in progress by a presenter, for example. In this example, the server 1 holds a document file to be used in a meeting, and additionally, a supplementary material file stored in advance in the server 1. Each page image 6C in the supplementary material file is associated appropriately with a page image 6 in the document file, and functions as a material supplementary to the associated document file. As an example, if the document file to be used in the meeting is written in English, each page image 6C in the supplementary material file contains Japanese translation of an associated page image 6.

In this example, the portable terminal device 3 of a participant acquires the document file and the supplementary material file from the server 1 at the start of the meeting. The portable terminal device 3 receives display page information from the portable terminal device 2 of a presenter through the server 1. The display controller 82 of the portable terminal device 3 displays, in the first divided region A2, a page image 6 that is in synchronization with page progress by the presenter, and at the same time, displays, in the second divided region A3, a page image 6C in the supplementary material file that is a material supplementary to the page image 6 displayed in the first divided region A2.

The function of the second divided region A3 can be selected from the functions described with reference to FIGS. 9 to 12, and these functions can be changed from one to another in response to operational input by a participant.

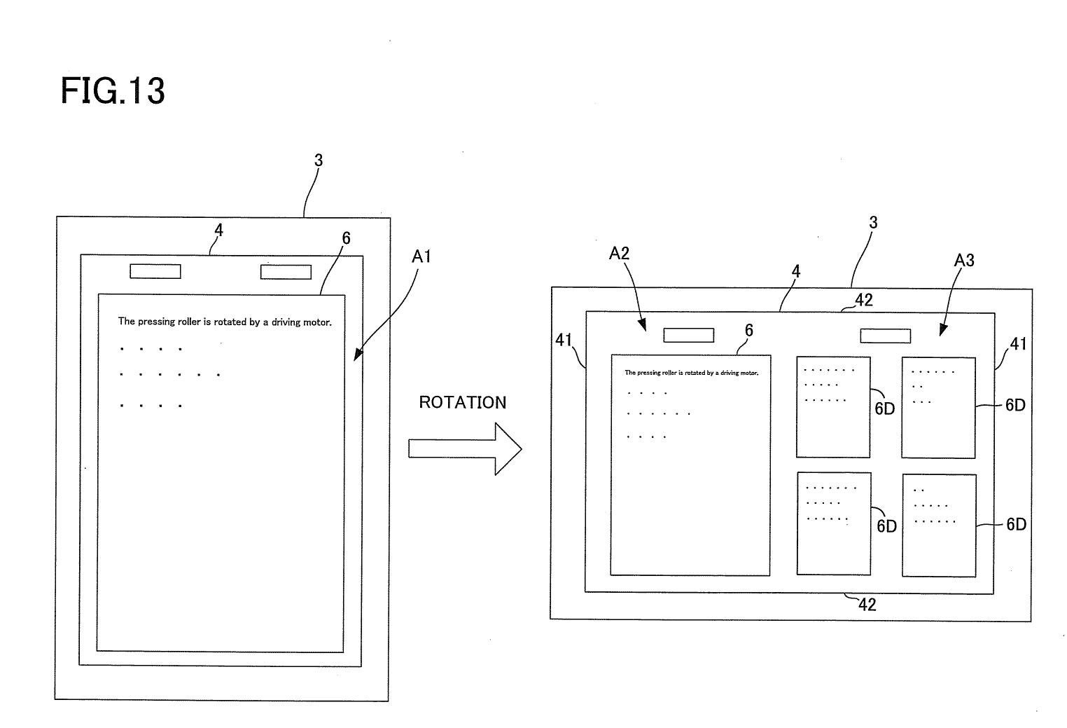

FIG. 13 is a diagram showing how the portable terminal device 3 operates if a page image 6 in a document file is in the portrait position.

If a page image 6 in a document file is in the portrait position while the display screen 4 is in the portrait position, the display controller 82 of the portable terminal device 3 places the display screen 4 in the first display condition to display the same page image 6 in the region A1 extending through the display screen 4 as that being in progress by a presenter. If the display screen 4 is rotated to change the position thereof to the landscape position, the display controller 82 changes the display condition of the display screen 4 to the second display condition. To be specific, the display controller 82 displays the same page image 6 with a reduced size while maintaining the aspect ratio thereof in the first divided region A2 closer to one of the screen's short sides 41 as that being in progress by a presenter.

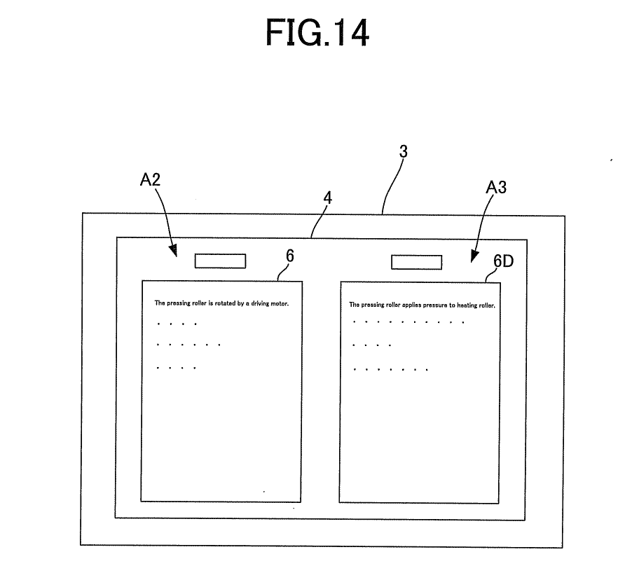

Further, the display controller 82 is capable of realizing various functions in the second divided region A3 closer to the other of the screen's short sides 41. In the example of FIG. 13, the display controller 82 displays thumbnail images of a plurality of page images 6D in order of pages in the second divided region A3 that are part of the document file containing the page image 6 displayed in the first divided region A2. At this time, if one of the page images 6D is selected, the display controller 82 displays only the selected page image 6D in an enlarged style in the second divided region A3 as shown in FIG. 14.

If a page image 6 in a document file is in the portrait position while the display screen 4 is in the landscape position, the display controller 82 is still capable of realizing the respective functions in the second divided region A3 described with reference to FIGS. 9 to 13. Further, the display controller 82 is capable of switching the functions described with reference to FIGS. 9 to 13 from one to another in response to operational input by a participant.

In the embodiment, the portable terminal device 3 of a participant is synchronized with the portable terminal device 2 of a presenter through the server 1. Meanwhile, the portable terminal device 3 of a participant may also be synchronized with the portable terminal device 2 of a presenter without the intervention of the server 1.

A display device of a presenter is not limited to a portable terminal device, but it may also be a desktop PC (personal computer).

In the embodiment, the accepting section 81 acquires instructions of change to change the display condition of the display screen 4 by causing the acceleration sensor 58 to detect change of the position of the display screen 4. Meanwhile, the accepting section 81 may also acquire instructions of change by being notified of operational input made by a participant and accepted by the operational input section 52.

A recording medium of any type is applicable if it is capable of storing a program, and capable of being read by a computer. By way of example, the recording medium is an internal storage device placed inside a computer such as a ROM and a RAM, a portable storage medium such as a CD-ROM, a flexible disk, a DVD disk, a magneto-optical disk and an IC card, a database storing a computer program, a different computer, or a database of the different computer. A function obtained by installation or downloading may be put into use in cooperation with an OS and the like in the device. A program may be an executable module part or all of which is generated dynamically.

As described in detail above, the technique described herein is capable of providing a technique of controlling display on a portable terminal device.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A portable terminal device, comprising:
a terminal display screen having an aspect ratio determined between a length and a width different from each other;
an accepting section configured to accept instructions of change to change a display condition of the terminal display screen; and
a display controller configured to change the display condition of the terminal display screen from a first display condition of displaying a first image to a second display condition in response to acceptance of the instructions of change by the accepting section, the second display condition being such that the first image displayed in the second display condition is reduced in size when compared with that of the first display condition, and that a second image not displayed in the first display condition is displayed in an empty region formed by reducing the size of the first image.

2. The portable terminal device according to claim 1, wherein the display controller displays an image displayed on a display screen of a display device as the first image on the terminal display screen, the display screen of the display device having an aspect ratio determined between a length and a width different from each other, and in response to change of the image on the display screen to a different image, the display controller displays the different image as the first image on the terminal display screen.

3. The portable terminal device according to claim 2, wherein the first image displayed on the terminal display screen has the same aspect ratio as that of an image displayed on the display screen.

4. The portable terminal device according to claim 1, wherein the accepting section accepts the instructions of change if the portable terminal device is rotated in a plane including the terminal display screen.

5. The portable terminal device according to claim 4, wherein
the first image displayed on the display screen is a landscape image, and
if the portable terminal device is rotated to a position corresponding to the landscape position, the display controller controls such that the terminal display screen is placed in the first display condition, and if the portable terminal device is rotated to a position corresponding to a portrait position, the display controller controls such that the terminal display screen is placed in the second display condition.

6. The portable terminal device according to claim 1, wherein the display controller displays a text input screen in the empty region, and saves text entered through the text input screen.

7. The portable terminal device according to claim 1, wherein
the accepting section includes an acceleration sensor configured to detect a position of the portable terminal device, and
acceptance of the instructions of change by the accepting section means that the accepting section determines on the basis of a detection signal from the acceleration sensor that the position of the terminal display screen has been changed between the landscape position and the portrait position.

8. A displaying system, comprising:
a display device including a display screen having an aspect ratio determined between a length and a width different from each other; and
a portable terminal device, including a terminal display screen having an aspect ratio determined between a length and a width different from each other; an accepting section configured to accept instructions of change to change a display condition of the terminal display screen; and a display controller configured to change the display condition of the terminal display screen from a first display condition of displaying a first image to a second display condition in response to acceptance of the instructions of change by the accepting section, the second display condition being such that the first image displayed in the second display condition is reduced in size when compared with that of the first display condition, and that a second image not displayed in the first display condition is displayed in an empty region formed by reducing the size of the first image.

9. The displaying system according to claim 8, wherein, in response to change of an image on the display screen of the display device to a different image, the display controller displays the different image as the first image on the terminal display screen.

10. The displaying system according to claim 9, wherein the first image displayed on the terminal display screen has the same aspect ratio as that of an image displayed on the display screen.

11. The displaying system according to claim 8, wherein the accepting section accepts the instructions of change if the portable terminal device is rotated in a plane including the terminal display screen.

12. The displaying system according to claim 11, wherein
the first image displayed on the display screen is a landscape image, and
if the portable terminal device is rotated to a position corresponding to the landscape position, the display controller controls such that the terminal display screen is placed in the first display condition, and if the portable terminal device is rotated to a position corresponding to a portrait position, the display controller controls such that the terminal display screen is placed in the second display condition.

13. The displaying system according to claim 8, wherein the display controller displays a text input screen in the empty region, and saves text entered through the text input screen.

14. The displaying system according to claim 8, wherein
the accepting section includes an acceleration sensor configured to detect the position of the portable terminal device, and
acceptance of the instructions of change by the accepting section means that the accepting section determines on the basis of a detection signal from the acceleration sensor that the position of the terminal display screen has been changed between the landscape position and the portrait position.

15. The displaying system according to claim 8, comprising a server configured to transmit a file with a plurality of pages to the display device and to transmit the file and a supplementary material file with pages associated with the pages of the file to the portable terminal device, the server also being configured to receive display page information indicating a display page from the display device and to transmit the display page information to the portable terminal device, and wherein
the display controller complies with switching of a page displayed on the display device to display a page displayed on the display device as the first image on the terminal display screen on the basis of the display page information, and the display controller displays a page in the supplementary material file associated with the displayed page in the empty region.

16. A method of controlling display on a portable terminal device with a terminal display screen having an aspect ratio determined between a length and a width different from each other, the method comprising:
accepting instructions of change to change a display condition of the terminal display screen; and
changing the display condition of the terminal display screen from a first display condition of displaying a first image to a second display condition in response to acceptance of the instructions of change, the second display condition being such that the first image displayed in the second display condition is reduced in size when compared with that of the first display condition, and that a second image not displayed in the first display condition is displayed in an empty region formed by reducing the size of the first image.

17. The method of controlling display according to claim 16, wherein, in response to change of an image on a display screen of a display device to a different image, the different image is displayed as the first image on the terminal display screen.

18. The method of controlling display according to claim 17, wherein the first image displayed on the terminal display screen has the same aspect ratio as that of an image displayed on the display screen.

19. The method of controlling display according to claim 16, wherein the instructions of change are accepted if the portable terminal device is rotated in a plane including the terminal display screen.

20. The method of controlling display according to claim 19, wherein
the first image displayed on the display screen is a landscape image, and
if the portable terminal device is rotated to a position corresponding to the landscape position, the terminal display screen is controlled to be placed in the first display condition, and if the portable terminal device is rotated to a position corresponding to a portrait position, the terminal display screen is controlled to be placed in the second display condition.
